(19) United States
(12) Patent Application Publication
(10) Pub. No.: US 2023/0071852 A1
(43) Pub. Date: Mar. 9, 2023

(54) DATA PROCESSING APPARATUS AND METHOD THEREOF

(71) Applicant: MEDIT CORP., Seoul (KR)

(72) Inventor: Maria ROSLYAKOVA, Seoul (KR)

(73) Assignee: MEDIT CORP., Seoul (KR)

(21) Appl. No.: 17/939,338

(22) Filed: Sep. 7, 2022

(30) Foreign Application Priority Data
Sep. 9, 2021 (KR) 10-2021-0120540
Jun. 24, 2022 (KR) 10-2022-0077708

(51) Int. Cl. A61C 9/00; A61C 13/00; A61C 7/00

(52) U.S. Cl. CPC A61C 9/0053; A61C 13/0004; A61C 7/002

(57) ABSTRACT

Provided is a data processing method using a data processing apparatus. The data processing method includes obtaining a 3D oral model including 3D scan data of an object; and generating a prosthesis for the object based on the 3D scan data of the object according to a module selected from a plurality of modules.

### CROSS-REFERENCE TO RELATED APPLICATIONS

This application is based on and claims priority under 35 U.S.C. § 119 to Korean Patent Application No. 10-2021-0120540, filed on Sep. 9, 2021, in the Korean Intellectual Property Office, and Korean Patent Application No. 10-2022-0077708, filed on Jun. 24, 2022, in the Korean Intellectual Property Office, the disclosures of which are incorporated by reference herein in their entireties, the disclosures of which are incorporated by reference herein in its entireties.

### BACKGROUND

### 1. Field

One or more embodiments relate to a data processing apparatus and a data processing method, and more particularly, to an apparatus and method for processing or managing an oral image.

### 2. Description of the Related Art

Along with technological advances, methods of creating an oral model using a 3D scanner and manufacturing prostheses using the oral model have been developed.

A user such as a dentist may perform tooth preparation by trimming a tooth in the form of an abutment tooth to secure a space to cover the tooth with a prosthesis, and may then restore the prepared tooth by using a manufactured prosthesis. A prosthesis finally used to restore a tooth may be referred to as a final prosthesis, and it takes from a few hours to several weeks to manufacture such a final prosthesis. Therefore, until a final prosthesis is manufactured, a patient waits in a state in which his/her prepared tooth is restored with a temporary prosthesis.

Because use of such a temporary prosthesis is not permanent, the temporary prosthesis does not need to precisely engage with a tooth which is prepared, but needs to be rapidly fabricated for restoring the tooth immediately after the tooth is prepared. Therefore, it is required to quickly design a temporary prosthesis using only scan data of a non-prepared tooth (pre-preparation or pre-operation tooth).

A temporary prosthesis may be generated for a tooth by using scan data (pre-preparation or pre-operation scan data) of the tooth before preparation and scan data (post-preparation or post-operation scan data) of the tooth after preparation. The temporary prosthesis, which is made using both the pre-preparation scan data of the tooth and the post-preparation scan data of the tooth, may be better fitted to the patient's tooth than a temporary prosthesis, which is made using only the pre-preparation scan data of the tooth. The temporary prosthesis made using both the pre-preparation scan data of the tooth and the post-preparation scan data of the tooth may be used to temporarily restore the tooth or may be manufactured as a final prosthesis through an additional process.

Furthermore, in some cases, it may be required to generate a temporary prosthesis even when only scan data of a prepared tooth is available for a tooth requiring prosthesis restoration, and there is no scan data of a tooth before preparation.

As described above, different types of prostheses may have different functions and may require different types of data to be designed. In addition, pieces of data necessary for designing prostheses are available at different times according to treatment processes, that is, according to tooth preparation. Therefore, there is a need for a technique for selectively designing suitable prostheses according to available scan data.

### SUMMARY

One or more embodiments include a data processing apparatus and method for generating prostheses for objects by using various modules.

One or more embodiments include a data processing apparatus and method for automatically selecting one module from a plurality of modules according to the type of scan data.

One or more embodiments include a data processing apparatus and method for identifying and displaying scan data, which is necessary for generating a prosthesis for an object with a selected module.

One or more embodiments include a data processing apparatus and method for simultaneously generating prostheses for a plurality of objects.

Additional aspects will be set forth in part in the description which follows and, in part, will be apparent from the description, or may be learned by practice of the presented embodiments of the disclosure.

According to one or more embodiments, a data processing method using a data processing apparatus includes: obtaining a 3D oral model including 3D scan data of an object; and generating a prosthesis for the object based on the 3D scan data of the object according to a module selected from a plurality of modules.

In an embodiment, the data processing method may further include selecting the module from the plurality of modules according to a type of the 3D scan data of the object.

In an embodiment, the selecting of the module from the plurality of modules may include selecting a first module on the basis that the 3D scan data of the object includes post-preparation 3D scan data of the object and does not include pre-preparation 3D scan data of the object, wherein the generating of the prosthesis may include: obtaining a library tooth corresponding to the object based on the selecting of the first module; and generating a first prosthesis using the post-preparation 3D scan data of the object and the library tooth.

In an embodiment, the selecting of the module from the plurality of modules may include selecting a second module on the basis that the 3D scan data of the object includes pre-preparation 3D scan data of the object and does not include post-preparation 3D scan data of the object, wherein the generating of the prosthesis may include generating a second prosthesis based on the selecting of the second module by using the pre-preparation 3D scan data of the object.

In an embodiment, the selecting of the module from the plurality of modules may include selecting a third module on the basis that the 3D scan data of the object includes post-preparation 3D scan data of the object and pre-preparation 3D scan data of the object, wherein the generating of the prosthesis may include generating a third prosthesis based on the selecting of the third module by using the post-preparation 3D scan data of the object and the pre-preparation 3D scan data of the object.

In an embodiment, the data processing method may further include receiving a selection of one module from the plurality of modules from a user.

In an embodiment, the data processing method may further include identifying, from the 3D scan data included in the 3D oral model, 3D scan data necessary for generating the prosthesis for the object by using the selected module.

In an embodiment, the 3D oral model may include 3D scan data of a dental arch opposite to the arch including the object, and the dental arch may include an antagonist tooth corresponding to the object, wherein the identifying of the 3D scan data necessary for generating the prosthesis for the object may include identifying the 3D scan data of the dental arch as the 3D scan data necessary for generating the prosthesis for the object.

In an embodiment, the generating of the prosthesis for the object may include generating the prosthesis for the object by using both the 3D scan data of the object and the 3D scan data of the dental arch.

In an embodiment, the identifying of the 3D scan data necessary for generating the prosthesis for the object may include identifying a type of the 3D scan data from identification information on the 3D scan data.

In an embodiment, the type of the 3D scan data comprises at least one piece of information indicating whether the 3D scan data is about maxilla or mandible, or information indicating whether the 3D scan data is about a pre-preparation tooth or a post-preparation tooth.

In an embodiment, when the object includes a plurality of objects, the generating of the prosthesis for the object may include generating prostheses together for the plurality of objects.

In an embodiment, when a portion of the object is included in maxilla and another portion of the object is included in mandible, the generating of the prosthesis for the object may include generating together a prosthesis for the portion of the object included in the maxilla and a prosthesis for the other portion of the object included in the mandible.

According to one or more embodiments, a data processing apparatus includes at least one processor configured to execute at least one instruction, wherein the at least one processor is configured to: execute the at least one instruction to obtain a 3D oral model including 3D scan data of an object; and generate a prosthesis for the object based on the 3D scan data of the object according to a module selected from a plurality of modules.

According to one or more embodiments, a non-transitory computer-readable recording medium having recorded thereon a program for executing a data processing method including: obtaining a 3D oral model including 3D scan data of an object; and generating a prosthesis for the object based on the 3D scan data of the object according to a module selected from a plurality of modules.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an oral image processing system according to an embodiment;

FIG. 2 is a block diagram illustrating an internal structure of a data processing apparatus according to an embodiment;

FIG. 3 is a view illustrating a module selection interface screen output by the data processing apparatus according to an embodiment;

FIG. 4 is a view illustrating a first module selection interface screen output by the data processing apparatus according to an embodiment;

FIG. 5 is a view illustrating a second module selection interface screen output by the data processing apparatus according to an embodiment;

FIG. 6 is a view illustrating a third module selection interface screen output by the data processing apparatus according to an embodiment;

FIGS. 7A to 7C are views illustrating how the data processing apparatus designs a second prosthesis using a second module according to an embodiment;

FIGS. 8A and 8B are views illustrating how the data processing apparatus generates a third prosthesis by using a third module according to an embodiment;

FIG. 9 is a view illustrating a multi-case in which an object includes a plurality of teeth;

FIG. 10 is a flowchart illustrating a data processing method according to an embodiment; and

FIG. 11 is a flowchart illustrating a method of selecting one module from a plurality of modules according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present specification clarifies the scope of the present application, and explains the principle of the present application and discloses embodiments, such that those of ordinary skill in the art to which the present application pertains may work the present application. The embodiments disclosed herein may be implemented in various forms.

In the drawings, like reference numerals refer to like elements. In the present specification, not all the elements of embodiments are described. That is, general elements in the technical field to which the present application pertains are not described, or the same description as that given in other embodiments is omitted. In the present specification, terms such as “part” or “portion” may be used to denote a part or portion that is implemented with hardware, software, or a combination of hardware and software, and in embodiments, a plurality of parts or portions may be included in one unit or element, or a part or portion may include a plurality of units or elements. Hereinafter, operational principles and embodiments of the present application will be described with reference to the accompanying drawings.

In the present specification, an image may refer to an image (“oral image”) of at least one tooth, the oral cavity including at least one tooth, or a plaster model of the oral cavity.

Furthermore, in the present specification, an image may refer to a 2D image of an object or a 3D oral image expressing an object in three dimensions. A 3D oral cavity image may be generated by modeling the structure of the oral cavity in three dimensions based on raw data, and may thus be referred to as a 3D oral cavity model. In addition, a 3D oral image may be referred to as a 3D scan model or 3D scan data.

Hereinafter, in the present specification, the oral image will be used as a generic term for a model or image representing the oral cavity in two or three dimensions.

Furthermore, in the present specification, raw data or the like may be obtained using at least one camera to express an object in two or three dimensions. For example, raw data may refer to data obtained to generate an oral image, and when an object is scanned using a 3D scanner, data (for example, 2D data) obtained using at least one image sensor included in the 3D scanner may be raw data. Raw data may be 2D image data or 3D image data.

In the present specification, the term “object” may refer to an object for which a prosthesis is designed, and the object may include a region to be restored with the prosthesis. The object may be an object to be scanned. The object may be a part of the body or may include a model modeled after a part of the body. The object may include the oral cavity, a plaster model or impression of the oral cavity, an artificial structure insertable into the oral cavity, or a plaster model or impression of the artificial structure. For example, the object may include at least one of teeth and gingivae, a plaster model or impression of at least one of teeth and gingiva, an artificial structure insertable into the oral cavity, and/or a plaster model or impression of the artificial structure. Here, the artificial structure insertable into the oral cavity may include, for example, at least one selected from the group consisting of an orthodontic device, an implant, a crown, an inlay, an onlay, an artificial tooth, and an orthodontic aid inserted into the oral cavity. In addition, the orthodontic device may include at least one selected from the group consisting of a bracket, an attachment, an orthodontic screw, a lingual orthodontic device, and a removable orthodontic maintenance device.

In the present disclosure, the term “prosthesis” may refer to an artificial device for protecting and restoring a defective tooth. The prosthesis may also be referred to as a crown. When one or several teeth are missing, a restoration treatment using a fixed prosthesis such as a crown or a bridge may be applied, and when the application of a fixed prosthesis is impossible or unesthetic, a removable partial denture, which is called artificial teeth, may be used to restore missing teeth. A tooth that supports a fixed or removable prosthesis is called an abutment or an abutment tooth. An abutment tooth may also be referred to as a preparation tooth, or a prepared tooth. A user such as a dentist may prepare teeth by trimming the teeth to secure a space through which the teeth are covered with a prosthesis.

A temporary prosthesis may be made, and abutment teeth may be restored with the temporary prosthesis to maintain the function of the teeth until a final prosthesis is prepared.

A user such as a dentist may acquire 3D scan data (pre-preparation or pre-operation 3D scan data) of a non-prepared object by scanning a non-prepared tooth using a 3D scanner. An oral image processing apparatus may quickly design a temporary prosthesis using pre-preparation 3D scan data obtained by scanning a non-prepared tooth. While the oral image processing apparatus designs the temporary prosthesis based on the pre-preparation 3D scan data of the non-prepared tooth, the user may prepare the tooth by trimming the tooth.

The user may acquire 3D scan data (post-preparation or post-operation 3D scan data) of the prepared tooth by scanning the prepared tooth using the 3D scanner. The oral image processing apparatus may design another type of temporary prosthesis by using both the pre-preparation 3D scan data of the tooth and the post-preparation 3D scan data of the tooth. The temporary prosthesis manufactured by using both the pre-preparation 3D scan data of the tooth and the post-preparation 3D scan data of the tooth may more precisely restore the tooth, and/or may be used as a final prosthesis after being additionally processed.

As described above, different types of prostheses may be required for different circumstances. In addition, the type of manufacturable prosthesis may vary depending on the type of scan data. Therefore, there is a need for a technique for designing various types of prostheses by using various modules according to the types of scan data.

To satisfy the above-described technical need, embodiments provide a data processing apparatus and method for designing various types of prostheses by using a plurality of modules.

Hereinafter, embodiments will be described with reference to the accompanying drawings.

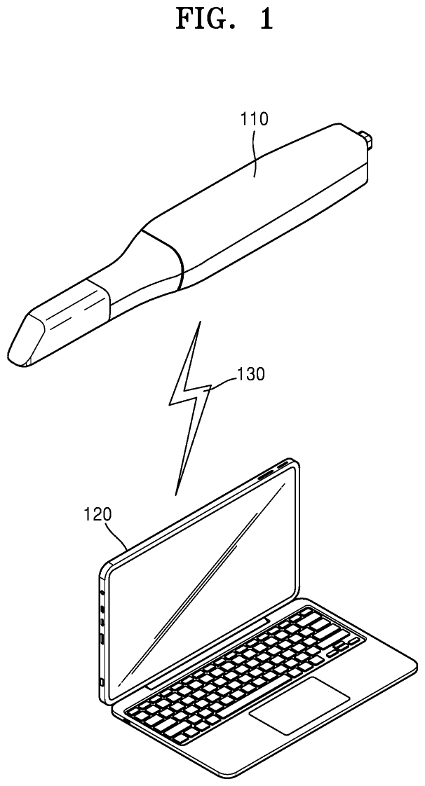

FIG. 1 is a view illustrating an oral image processing system according to an embodiment.

Referring to FIG. 1, the oral image processing system may include a 3D scanner 110 and a data processing apparatus 120 connected to the 3D scanner 110 through a communication network 130.

The 3D scanner 110 may be a medical device for acquiring images of an object.

The 3D scanner 110 may acquire an image of at least one selected from the group consisting of the oral cavity, an artificial structure, and a plaster model of the oral cavity or the artificial structure.

The 3D scanner 110 may be a handheld-type intraoral scanner, which a user may hold and move with his/her hand to scans the oral cavity. The 3D scanner 110 may be inserted into the oral cavity to scan teeth in a non-contact manner for acquiring an image of the oral cavity including at least one tooth.

In FIG. 1, the 3D scanner 110 is illustrated as a handheld-type intraoral scanner, but is not limited thereto. For example, the 3D scanner 110 may be a table scanner.

The 3D scanner 110 may acquire, as raw data, data on the surface of at least one object selected from the group consisting of teeth or gingivae in the oral cavity and artificial structures insertable into the oral cavity (for example, orthodontic devices such as brackets and wires, implants, artificial teeth, orthodontic aids insertable into the oral cavity, etc.) so as to image the surface of the at least one object.

The 3D scanner 110 may transmit the raw data to the data processing apparatus 120 through the communication network 130.

The data processing apparatus 120 may be connected to the 3D scanner 110 through the communication network 130 which is a wireless or wired communication network. The data processing apparatus 120 may be any electronic apparatus capable of receiving raw data from the 3D scanner 110 and generating, processing, displaying, and/or transmitting an oral image based on the received raw data. For example, the data processing apparatus 120 may be a computing apparatus such as a smartphone, a laptop computer, a desktop computer, a personal digital assistant (PDA), or a tablet PC, but is not limited thereto. In addition, the data processing apparatus 120 may a server (or server device) configured to process oral images.

The data processing apparatus 120 may generate a 3D oral image based on the raw data received from the 3D scanner 110. The data processing apparatus 120 may display the 3D oral image on a display, or may output or transmit the 3D oral image to an external device.

In another example, the 3D scanner 110 may acquire raw data by scanning the oral cavity, process the raw data to generate 3D information, and transmit the 3D information to the data processing apparatus 120.

In an embodiment, the 3D scanner 110 may acquire 3D information about an object in various manners. For example, the 3D scanner 110 may acquire 3D information about an object by a confocal method. In another example, the 3D scanner 110 may acquire 3D information about an object by an optical triangulation method. However, these are merely examples. The 3D scanner 110 may acquire 3D information from raw data by using various methods other than the confocal method or the optical triangulation method and may transmit the 3D information to the data processing apparatus 120.

The data processing apparatus 120 may analyze, process, treat, display, and/or transmit the received 3D information.

In an embodiment, the data processing apparatus 120 may generate a 3D oral model based on raw data and/or 3D information received from the 3D scanner 110. The 3D oral model may include 3D scan data of an object.

In an embodiment, the data processing apparatus 120 may generate a prosthesis for an object based on 3D scan data of the object according to one module selected from a plurality of modules.

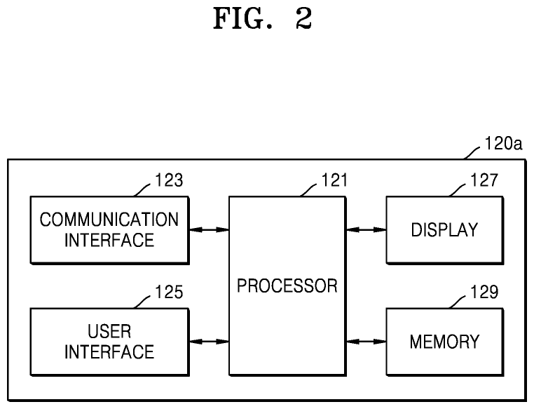

FIG. 2 is a block diagram illustrating the internal structure of a data processing apparatus 120a according to an embodiment.

In an embodiment, the data processing apparatus 120a may also be referred to as an oral image processing apparatus.

The data processing apparatus 120a shown in FIG. 2 may be an embodiment of the data processing apparatus 120 shown in FIG. 1. Therefore, the same description as the description of the data processing apparatus 120 shown in FIG. 1 will be omitted.

Referring to FIG. 2, the data processing apparatus 120a may include a processor 121, a communication interface 123, a user interface 125, a display 127, and a memory 129.

The data processing apparatus 120a may generate, process, treat, display, and/or transmit a 3D oral model by using raw data and/or 3D information received from the 3D scanner 110. Alternatively, the data processing apparatus 120a may receive a 3D oral model from an external server or an external device through a wired or wireless communication network.

In an embodiment, the memory 129 may store at least one instruction. The memory 129 may store at least one instruction or program executable by the processor 121.

In an embodiment, the memory 129 may store data received from the 3D scanner 110, such as raw data or 3D information obtained by scanning the oral cavity or an oral model. The memory 129 may store point location information and point connection relationship information of 3D oral data received from the 3D scanner 110. In addition, the memory 129 may store a 3D oral model, which is generated by the data processing apparatus 120a or received from the 3D scanner 110, an external server, or an external device.

In an embodiment, the memory 129 may store dedicated software executable in connection with the 3D scanner 110. Here, the dedicated software may refer to a dedicated program or application. When the data processing apparatus 120a operates in connection with the 3D scanner 110, the dedicated software stored in the memory 129 may be connected to the 3D scanner 110 and may receive, in real time, data acquired by scanning an object. The dedicated software may provide a user interface on the display 127 such that a user may use data acquired by the 3D scanner 110. A user interface screen provided by the dedicated software may include 3D scan data of an object.

In an embodiment, the memory 129 may store a plurality of 3D oral models.

In an embodiment, a 3D oral model may include 3D scan data of an object. The 3D scan data of the object may include at least one piece of data selected from the group consisting of 3D scan data (pre-preparation 3D scan data of the object acquired before the object is prepared, and 3D scan data (post-preparation 3D scan data) of the object acquired after the object is prepared.

In an embodiment, a 3D oral model may include 3D scan data of a dental arch opposite to/facing an arch in which the object is included. For example, when the object is a tooth included in the maxilla, the 3D oral model may further include 3D scan data of the mandible that occludes with the maxilla. The 3D scan data of the opposite dental arch may be pre-preparation 3D scan data. In an embodiment, the 3D scan data of the opposite dental arch of the object may include 3D scan data of an antagonist tooth corresponding to the object and/or 3D scan data of a tooth region surrounding the antagonist tooth. The 3D scan data of the antagonist tooth in the opposite dental arch may be pre-preparation 3D scan data of the antagonist tooth.

In an embodiment, the memory 129 may store identification information on 3D scan data of a 3D oral model. The identification information on the 3D scan data may be information on the type of the 3D scan data. The identification information on the 3D scan data may include at least one piece of information selected from the group consisting of information indicating whether the 3D scan data is about the maxilla or the mandible, and information indicating whether the 3D scan data is about a pre-preparation tooth or a post-preparation tooth. The identification information on the 3D scan data may be stored in the memory 129 in the form of an index, a tag, or a file name for the 3D scan data, together with the 3D scan data.

In an embodiment, the memory 129 may store library teeth. The library teeth may be reference sample teeth used to design prostheses. In an embodiment, the library teeth may be virtually designed sample teeth. Alternatively, the library teeth may be 3D scan data obtained by scanning the teeth of persons other than patients. For example, the library teeth may be data obtained by scanning the teeth of others who have ideal teeth or teeth of a style that people prefer.

There may be a case in which it is difficult to obtain pre-preparation 3D scan data of an object because the object is already prepared. In this case, by using the library tooth as the pre-preparation shape of the object, a prosthesis having the shape of the library tooth as an outer shape may be designed.

In an embodiment, the memory 129 may store at least one library tooth for each of a plurality of teeth included in the oral cavity.

In an embodiment, the data processing apparatus 120a may acquire 3D scan data of another person's teeth and store the 3D scan data in the memory 129 as library teeth. Alternatively, the data processing apparatus 120a may download a set of library teeth previously stored in an external server, an external storage medium, or the like and may store the set of library teeth in the memory 129. However, this is merely an example embodiment. For example, library teeth may not be stored in the memory 129 but may be stored in an electronic device, a database, an external server, or the like, which is separate from the data processing apparatus 120a. In this case, the data processing apparatus 120a may acquire necessary library teeth by searching the external server or the like through a wired or wireless communication network and may store only the acquired necessary library teeth in the memory 129.

In an embodiment, the memory 129 may store at least one instruction for designing a prosthesis for an object based on 3D scan data of the object.

In an embodiment, dedicated software for designing a prosthesis for an object based on 3D scan data of the object may be stored in the memory 129. The dedicated software for designing prostheses may be referred to as a dedicated program, a dedicated tool, a dedicated application, or the like. The dedicated software may design a prosthesis for an object according to one of a plurality of modules based on previously acquired and stored 3D scan data of the object.

In an embodiment, the data processing apparatus 120a may include the processor 121 to execute the at least one instruction. The processor 121 may be one or a plurality of processors. For example, the processor 121 may execute the at least one instruction to control at least one element of the data processing apparatus 120a and thus to perform an intended operation. Therefore, even when the processor 121 is described as performing a certain operation, this may mean that the processor 121 controls at least one element of the data processing apparatus 120a to perform the certain operation.

Here, the at least one instruction may be stored in the memory 129 of the data processing apparatus 120a which is separately from the processor 121, or may be stored in an internal memory (not shown) of the processor 121.

In an embodiment, the at least one instruction may include, but is not limited to, an instruction for executing software dedicated for designing prostheses.

In an embodiment, the at least one instruction may include an instruction for selecting one module from a plurality of modules based on 3D scan data of an object and generating a prosthesis for the object according to the selected module.

In an embodiment, the processor 121 may acquire a 3D oral model including 3D scan data of an object by executing the at least one instruction.

In an embodiment, the object may be at least one of teeth to be restored with a prosthesis and the gingivae around the teeth.

In an embodiment, the processor 121 may select one module for designing a prosthesis from a plurality of modules by executing the at least one instruction.

In an embodiment, the processor 121 may generate a prosthesis for an object based on 3D scan data of the object according to a selected module by executing the at least one instruction.

In an embodiment, generating a prosthesis for an object by the data processing apparatus 120a may include designing the prosthesis for the object. The expression “designing a prosthesis for an object” may refer to formatively designing a 3D prosthesis model before fabricating the prosthesis as a product. The prosthesis designed by the data processing apparatus 120a may be fabricated as a product by using a 3D printer or a miller and may be used to restore to the object.

In an embodiment, the processor 121 may select one module from a plurality of modules by executing the at least one instruction. In the present disclosure, the term “module” may refer to a set of instructions for performing a prosthesis design function. In an embodiment, modules used for designing prostheses may include at least one of a first module, a second module, and a third module.

In an embodiment, the processor 121 may automatically select one module from a plurality of modules according to the type of 3D scan data of an object by executing the at least one instruction.

In an embodiment, the processor 121 may control the display 127 by executing at least one instruction to output a module selection interface screen.

In an embodiment, the processor 121 may control the display 127 by executing the at least one instruction to output, on a screen, data available for designing a prosthesis for an object. The data available for designing a prosthesis for an object may include at least one of a piece of 3D scan data of the object, a piece of 3D scan data of a dental arch opposite to an arch including the object, and library teeth for the object. The 3D scan data of the dental arch opposite to the arch including the object may include 3D scan data of an antagonist tooth.

In an embodiment, the processor 121 may select the first module on the basis that 3D scan data of an object includes post-preparation 3D scan data of the object but does not include pre-preparation 3D scan data of the object. In an embodiment, the first module may be a module for designing a prosthesis using only the post-preparation 3D scan data of the object among the 3D scan data obtained by scanning the object. Hereinafter, a prosthesis designed using the first module will be referred to as a first prosthesis.

In an embodiment, the processor 121 may acquire a library tooth corresponding to the object based on the selection of the first module. The library teeth which are reference sample teeth may be virtually-designed sample teeth or scan data obtained by scanning other people's teeth. In an embodiment, the processor 121 may generate a first prosthesis by using the post-preparation 3D scan data of the object together with the library tooth corresponding to the object. The first prosthesis may be designed using the library tooth as an outer surface of the first prosthesis and the prepared object as the inner surface of the first prosthesis.

In an embodiment, the processor 121 may select the second module on the basis that the 3D scan data of the object includes the pre-preparation 3D scan data of the object but does not include the post-preparation 3D scan data of the object. In an embodiment, the second module may be a module for designing a prosthesis using only the pre-preparation 3D scan data of the object among the 3D scan data obtained by scanning the object. Hereinafter, a prosthesis designed using the second module will be referred to as a second prosthesis. In an embodiment, the processor 121 may generate a second prosthesis based on the pre-preparation 3D scan data of the object based on the selection of the second module.

In an embodiment, the processor 121 may select the third module on the basis that the 3D scan data of the object includes both the post-preparation 3D scan data of the object and the pre-preparation 3D scan data of the object. In an embodiment, the third module may be a module for designing a prosthesis by using both the post-preparation 3D scan data of the object and the pre-preparation 3D scan data of the object. Hereinafter, a prosthesis designed using the third module will be referred to as a third prosthesis. In an embodiment, the processor 121 may generate a third prosthesis by using the post-preparation 3D scan data of the object and the pre-preparation 3D scan data of the object based on the selection of the third module.

In another embodiment, the processor 121 may manually select one module from the plurality of modules. A user may select one module from the plurality of modules by using a module selection interface screen output by the display 127. For example, when the 3D scan data of the object includes both the post-preparation 3D scan data of the object and the pre-preparation 3D scan data of the object, a user may select one of the first module, the second module, and the third module to design a prosthesis for the object according to the selected module.

In an embodiment, the processor 121 may identify, among 3D scan data included in a 3D oral model, 3D scan data necessary to generate a prosthesis for an object by using a selected module. For example, when the first module is selected, the processor 121 may determine whether the 3D scan data includes post-preparation 3D scan data of the object. For example, when the third module is selected, the processor 121 may identify whether the 3D scan data includes both the post-preparation 3D scan data of the object and pre-preparation 3D scan data of the object.

In an embodiment, when the processor 121 identifies that there is 3D scan data necessary to generate a prosthesis for an object by using a selected module, the processor 121 may control the display 127 to display that the identified 3D scan data is 3D scan data necessary for generating a prosthesis for the object. For example, among the 3D scan data of the 3D oral model, the identified 3D scan data necessary to generate a prosthesis for the object may be moved by the processor 121 from an original position to another position on a screen output on the display 127. Alternatively, the processor 121 may differently display the color, brightness, transparency, thickness, or the like of the identified 3D scan data necessary to generate a prosthesis for the object, or a border surrounding the necessary 3D scan data, and thus the necessary 3D scan data may be distinguished from the other 3D scan data.

In an embodiment, the 3D oral model may include 3D scan data of a dental arch that is opposite to the arch including the object. The 3D scan data of the opposite dental arch may include 3D scan data of an antagonist tooth corresponding to the object and a tooth region around the antagonist tooth. The 3D scan data of the antagonist tooth may refer to pre-preparation 3D scan data obtained by scanning the antagonist tooth before the antagonist tooth is prepared. In an embodiment, the processor 121 may also identify 3D scan data of the opposite dental arch or the antagonist tooth as 3D scan data necessary for generating a prosthesis for the object.

In an embodiment, when there is 3D scan data of the opposite dental arch or antagonist tooth, the processor 121 may use the 3D scan data of the object and the 3D scan data of the opposite dental arch or antagonist tooth together to generate a prosthesis for the object.

In an embodiment, the processor 121 may acquire identification information on the 3D scan data to identify 3D scan data necessary to generate a prosthesis for the object. The processor 121 may identify the type of the 3D scan data based on the identification information on the 3D scan data. In an embodiment, the type of the 3D scan data includes at least one piece of information indicating whether the 3D scan data is about the maxilla or the mandible, and information indicating whether the 3D scan data is about a pre-preparation tooth or a post-preparation tooth.

In an embodiment, the object for generating the prosthesis may be one object or a plurality of objects. When there are a plurality of objects, the processor 121 may design a prosthesis or multiple prostheses for the plurality of objects together. In some cases, some of the plurality of objects may be included in the maxilla, and the other may be included in the mandible. In these cases, the processor 121 may design a prosthesis for the objects included in the maxilla and a prosthesis for the objects included in the mandible together.

In an embodiment, the display 127 may output a 3D oral model. In an embodiment, the display 127 may output a module selection interface screen with which a module to be used for designing a prosthesis is selectable. In an embodiment, the display 127 may output data usable for designing a prosthesis for an object. In an embodiment, data usable for designing a prosthesis with the selected module may be displayed distinguishably from among available data by the display 127. When one module is selected from a plurality of modules, the display 127 may output a screen for designing a prosthesis according to the selected module.

In an embodiment, the communication interface 123 may communicate with at least one external electronic device through a wired or wireless communication network.

For example, the communication interface 123 may communicate with the 3D scanner 110 under the control of the processor 121. In an embodiment, the communication interface 123 may receive raw data from the 3D scanner 110 or obtain 3D information. In an embodiment, the communication interface 123 may acquire a scan model by communicating with a device such as an external electronic device or an external server other than the 3D scanner 110.

The communication interface 123 may include at least one short-distance communication module capable of performing communication according to communication standards such as Bluetooth, Wi-Fi, Bluetooth Low Energy (BLE), NFC/RFID, Wifi Direct, UWB, or ZIGBEE.

In addition, the communication interface 123 may further include a remote communication module capable of communicating, according to a long-distance communication standard, with a server that supports long-distance communication. For example, the communication interface 123 may include a remote communication module capable of performing communication through a network for Internet communication. For example, the communication interface 123 may include a remote communication module capable of performing communication through a communication network conforming to a communication standard such as 3G, 4G, and/or 5G.

In addition, the communication interface 123 may perform wired communication with the 3D scanner 110, an external server, an external electronic device, and the like. To this end, the communication interface 123 may include at least one port for connection with the 3D scanner 110 or an external electronic device through a cable. The communication interface 123 may communicate with the 3D scanner 110 or an external electronic device that is connected to the at least one port of the communication interface 123 through a cable.

In an embodiment, the communication interface 123 may transmit a designed prosthesis to an external electronic device or an external server. For example, the communication interface 123 may transmit a designed prosthesis to a 3D printer or a miller.

In an embodiment, the user interface 125 may receive a user's input for controlling the data processing apparatus 120a. The user interface 125 may include a user input device such as a touch panel for sensing a user's touch, a button for receiving a user's push manipulation, or a mouse or keyboard for designating or selecting a point on a user interface screen. However, the user interface 125 is not limited thereto. In addition, the user interface 125 may include a voice recognition device for voice recognition. For example, the voice recognition device may be a microphone and may receive a user's voice command or voice request. In response to the user's voice command or voice request, a corresponding operation may be performed under the control of the processor 121.

In an embodiment, the user interface 125 may receive a prosthesis design command from a user such as a dentist.

In an embodiment, the user interface 125 may receive a user's selection of one module from a plurality of modules for designing prostheses.

In an embodiment, the user interface 125 may receive a user's selection of a data type for designing a prosthesis.

As described above, according to an embodiment, the data processing apparatus 120a may select a module from a plurality of modules based on the type of available 3D scan data of an object. Furthermore, according to an embodiment, the data processing apparatus 120a may generate a prosthesis for the object according to the selected module.

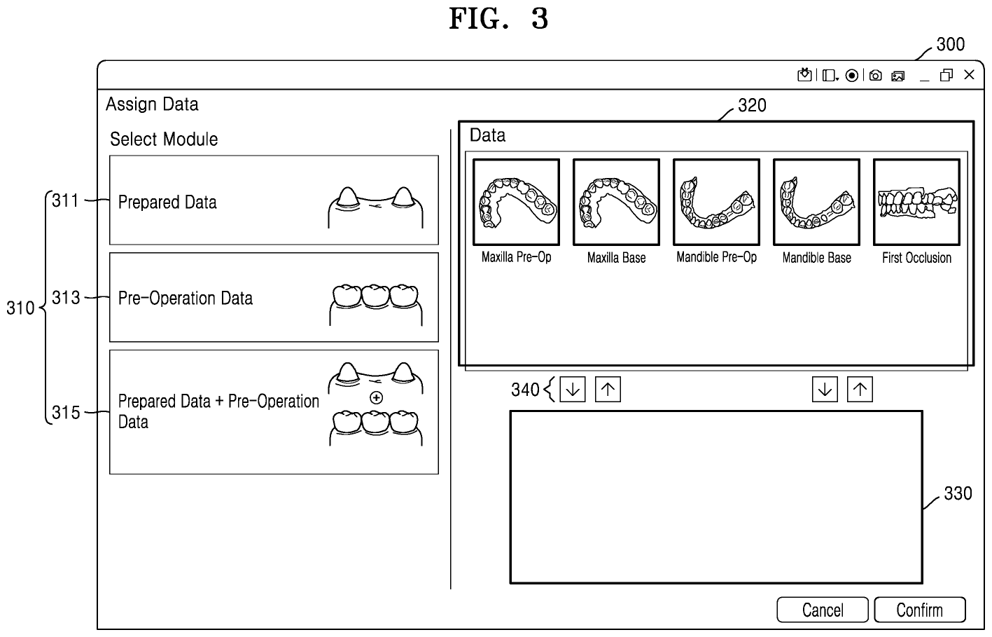

FIGS. 3 to 6 are views illustrating module selection interface screens output by the data processing apparatus 120a according to embodiments.

FIG. 3 is a view illustrating a module selection interface screen 300 output by the data processing apparatus 120a according to an embodiment.

In an embodiment, the module selection interface screen 300 may be a screen with which a module is selectable.

Referring to FIG. 3, the module selection interface screen 300 may include a module selection region 310 in a partial region thereof. FIG. 3 illustrates that the module selection region 310 is located on the left side of the module selection interface screen 300. The module selection region 310 may include a plurality of module selection buttons. FIG. 3 illustrates that the module selection region 310 includes a first module selection button 311, a second module selection button 313, and a third module selection button 315. However, this is an embodiment, and only one or two module selection buttons may be included in the module selection region 310.

Each of the module selection buttons may include at least one of a module name and the type of data essential for generating a prosthesis using the corresponding module. For example, the module name may be a number-based name such as a first module, a second module, a third module, or may be a feature-indicating name such as a library module, an eggshell module, or a temporary module. The data essential for generating a prosthesis may refer to 3D scan data of an object that is definitely necessary for generating a prosthesis for the object with the corresponding module. The type of data essential for generating a prosthesis for an object may include at least one piece of data of pre-preparation 3D scan data of the object and post-preparation 3D scan data of the object. In an embodiment, each of the module selection buttons may include at least one of text and images indicating the type of data essential for generating a prosthesis.

In FIG. 3, a plurality of module selection buttons are provided separate from each other in a rectangular shape, and the type of data essential for generating a prosthesis is shown using text and an image on each of the plurality of rectangular module selection buttons.

In an embodiment, the module selection interface screen 300 may include an acquired data display region 320 in a partial region thereof to indicate data available for designing a prosthesis for an object. The acquired data display region 320 may include available 3D scan data acquired by the data processing apparatus 120a, such as 3D scan data of an object, 3D scan data of an opposite dental arch or an antagonist tooth included in the opposite dental arch, and 3D scan data of occlusion, or library teeth. Data included in the acquired data display region 320 may be expressed using at least one selected from the group consisting of a data type, a file name, and an image.

For example, FIG. 3 shows that the acquired data display region 320 is provided at the upper right side of the module selection interface screen 300. Furthermore, in the acquired data display region 320, a plurality of 3D oral models usable by the data processing apparatus 120a are shown using images and identification information of each model.

In an embodiment, the module selection interface screen 300 may include an allocated data display region 330 in a partial region thereof. FIG. 3 shows an example in which the allocated data display region 330 is provided at the lower right side of the module selection interface screen 300.

In an embodiment, the allocated data display region 330 may be a region in which data selected from data shown in the acquired data display region 320 for generating a prosthesis with a selected module is separately collected. As shown in FIG. 3, in a state in which a specific module among a plurality of modules is not selected, the allocated data display region 330 may be in an empty state.

In an embodiment, user may select data move buttons 340 to move data between the acquired data display region 320 and the allocated data display region 330.

FIG. 3 shows merely an embodiment, and the sizes, positions, arrangement, and/or shapes of the module selection region 310 and/or the module selection buttons 311, 313, 315; the acquired data display region 320; the allocated data display region 330; and the data move buttons 340 may be variously modified.

As described above, according to embodiments, the data processing apparatus 120a may output the module selection interface screen 300 to allow module selection. In addition, the data processing apparatus 120a may distinguishably output data available for generating a prosthesis, and data actually used for generating a prosthesis according to a selected module.

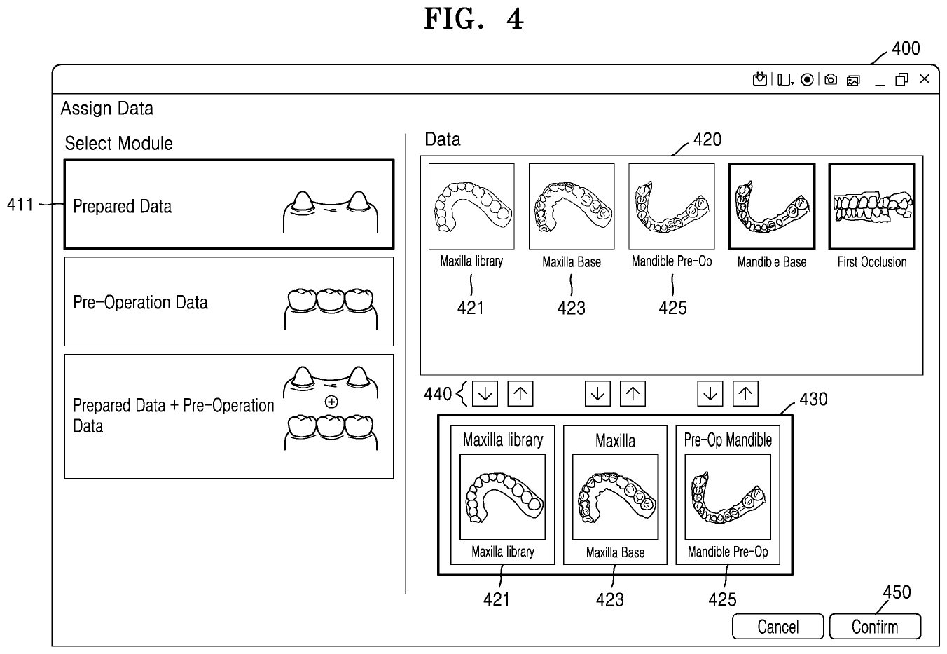

FIG. 4 is a view illustrating a first module selection interface screen 400 output by the data processing apparatus 120a according to an embodiment.

In an embodiment, when the first module is selected, the data processing apparatus 120a may output the first module selection interface screen 400 as shown in FIG. 4.

Like the module selection interface screen 300 shown in FIG. 3, the first module selection interface screen 400 may include, in partial regions thereof, a module selection region and an acquired data display region 420. The acquired data display region 420 may be a region in which data available for designing a prosthesis for an object is collected. The data available for designing a prosthesis for an object may include 3D scan data of the object.

The data processing apparatus 120a may acquire 3D scan data of an object in real time from the 3D scanner 110, read previously-stored 3D scan data of an object from the memory 129, or obtain 3D scan data of an object from an external server or the like. The data processing apparatus 120a may output the 3D scan data of the object to the acquired data display region 420.

The first module selection interface screen 400 may include an allocated data display region 430. The allocated data display region 430 may be a region in which data actually usable for designing an object with a selected module is collected.

In an embodiment, the first module may use a library tooth. The first module may be a module usable for the case in which only post-preparation 3D scan data of an object is obtainable and pre-preparation 3D scan data of the object is not obtainable, for example, when the object for which the prosthesis is to be designed has already been prepared. In an embodiment, when only post-preparation 3D scan data of an object is available and pre-preparation 3D scan data of the object is not available, the data processing apparatus 120a may refer to a library tooth for a pre-preparation shape of the object and may design a prosthesis having the shape of the library tooth as an outer shape thereof.

In an embodiment, based on the selection of the first module, the data processing apparatus 120a may acquire a library tooth corresponding to an object from the memory 129, a database, or an external server.

In an embodiment, one or more library teeth may be previously prepared as a sample tooth or teeth for each tooth. In an embodiment, the library teeth may be virtual sample teeth previously designed for each tooth number and stored in the memory 129, a database, an external server, or the like. Alternatively, the library teeth may be sample teeth obtained by scanning the teeth of people other than patients. In this case, scan data of other people's teeth may be stored as library teeth for each tooth number. In addition, different people's teeth may be used as library teeth for teeth having different numbers. In addition, when prostheses for a plurality of objects are generated together, virtually designed sample teeth may be used as library teeth for some of the objects, and scan data of other people's teeth may be used as library teeth for the other of the objects.

In an embodiment, when the first module is selected, the data processing apparatus 120a may identify the unique number of a target tooth included in the object. For example, the data processing apparatus 120a may receive the unique number of the target tooth included in the object from a user. The data processing apparatus 120a may use the unique number of the target tooth to obtain a library tooth, which is prepared corresponding to the number of the target tooth. When there are a plurality of library teeth prepared corresponding to the unique number of the target tooth, the data processing apparatus 120a may select a library tooth determined to be most similar to the target tooth from the plurality of library teeth. The similarity between the target tooth and the library tooth may be determined by considering at least one selected from the group consisting of the age, gender, and nationality of a patient, and the size of the target tooth.

In an embodiment, the data processing apparatus 120a may automatically select the first module from the plurality of modules according to the types of available 3D oral models.

In an embodiment, when the available 3D oral models include post-preparation 3D scan data of an object, which is essential for generating a prosthesis using the first module, but do not include pre-preparation 3D scan data of the object, the data processing apparatus 120a may automatically select the first module.

Alternatively, in another embodiment, a user such as a dentist may manually select a first module selection button 411 from a plurality of module selection buttons. A user may select the first module selection button 411 by using the user interface 125 including at least one selected from the group consisting of a touch panel for sensing a user's touch, a button for receiving a user's push operation, a mouse or keyboard for designating or selecting a point on a user interface screen, and a user voice recognition device.

In an embodiment, when the data processing apparatus 120a receives a user's input commanding the selection of the first module selection button 411, the data processing apparatus 120a may determine that the 3D oral models in the acquired data display region 420 include post-preparation 3D scan data of an object. When the 3D oral models in the acquired data display region 420 include post-preparation 3D scan data of an object, the data processing apparatus 120a may display the first module selection button 411 differently from the other selection buttons to indicate the selection of the first module selection button 411.

In an embodiment, when the 3D oral models in the acquired data display region 420 do not include post-preparation 3D scan data of an object even though the data processing apparatus 120a receives a user's input commanding the selection of the first module selection button 411, the data processing apparatus 120a may ignore the user's input commanding the selection of the first module selection button 411 or may output a message stating that the first module selection button 411 is not selectable. And/or, the data processing apparatus 120a may output a message stating that post-preparation 3D scan data of the object is required to select the first module selection button 411, or may output a screen for performing a scan operation together with the message stating that post-preparation 3D scan data of the object is required to select the first module selection button 411. Alternatively, the data processing apparatus 120a may display the first module selection button 411 in a selected state but may deactivate a confirm button 450 such that a user may not select the confirm button 450.

In an embodiment, when the data processing apparatus 120a receives a user's input commanding the selection of the first module selection button 411 in a state in which the 3D oral models in the acquired data display region 420 include post-preparation 3D scan data of the object and pre-preparation 3D scan data of the object, the data processing apparatus 120a may design a first prosthesis by using a library tooth instead of the pre-preparation 3D scan data of the object such that the first prosthesis may have an outer surface shaped after the shape of the library tooth and an inner surface shaped based on the post-preparation 3D scan data of the object.

In an embodiment, when the data processing apparatus 120a automatically selects the first module or receives a user's manual input of selecting the first module, the data processing apparatus 120a may display that the first module is selected. For example, as shown in FIG. 4, the data processing apparatus 120a may display the border of the first module selection button 411 thicker and darker than the borders of the other module selection buttons to indicate the selection of the first module selection button. Alternatively, the data processing apparatus 120a may indicate the selection of the first module selection button 411 by displaying the size or border color of the first module selection button 411, the color or darkness of text or image on the first module selection button 411, the overall shade or color of the first module selection button 411, or the like differently from those of the other module selection buttons which are not selected.

In an embodiment, data available for designing a prosthesis for an object may further include, in addition to 3D scan data of the object, 3D scan data of a dental arch opposite to the object, 3D scan data of an antagonist tooth included in the opposite dental arch, or 3D scan data of occlusion.

In an embodiment, data available for designing a prosthesis for an object by using the first module may include, in addition to 3D scan data of the object, 3D scan data of an antagonist tooth included in a dental arch opposite to the object. When designing a prosthesis for restoring an object, fitting between the prosthesis and an antagonist tooth is considered. When the object is restored with the prosthesis, interference (intersection) between the prosthesis and an antagonist tooth may damage the prosthesis and the antagonist tooth and make the patient uncomfortable. Therefore, when acquired available data on an object includes 3D scan data of an antagonist tooth included in a dental arch opposite to the object, the data processing apparatus 120a may design a prosthesis for the object by using the 3D scan data of the antagonist tooth. Here, the 3D scan data of the antagonist tooth may refer to pre-preparation 3D scan data of the antagonist tooth. However, the use of the 3D scan data of the antagonist tooth is optional, and when the 3D scan data of the antagonist tooth of the opposite dental arch is not contained in the acquired data display region 420, the data processing apparatus 120a may design a prosthesis for the object without considering the 3D scan data of the antagonist tooth.

In an embodiment, when the first module is selected, the data processing apparatus 120a may identify data usable for generate a prosthesis using the first module and may display the identified data. For example, the data processing apparatus 120a may output, to the allocated data display region 430, 3D scan data to be used for designing a prosthesis for an object based on automatic or manual selection of the first module. For example, the data processing apparatus 120a may move, to the allocated data display region 430, data to be used for generating a prosthesis among data included in the acquired data display region 420, such that data actually to be used for designing a prosthesis using the first module may be displayed distinguishably from other the data.

In FIG. 4, it is assumed that an object to be restored with a prosthesis is included in the maxilla. As shown in FIG. 4, the data processing apparatus 120a may automatically move post-preparation 3D scan data (Maxilla base) 423 of an object, which is data essential for designing a prosthesis for the object by using the first module, from the acquired data display region 420 to the allocated data display region 430 based on the selection of the first module, and thus the post-preparation 3D scan data 423 of the object may be contained in the allocated data display region 430. In addition, the data processing apparatus 120a may automatically move 3D scan data (Mandible Pre-Op) 425 of the mandible contained in the acquired data display region 420 to the allocated data display region 430 such that the 3D scan data 425 may be contained in the allocated data display region 430.

At the same time, the data processing apparatus 120a may indicate that the post-preparation 3D scan data 423 of the object and the 3D scan data 425 of the mandible is no longer included in the acquired data display region 420 by various methods such as removing, blurring, or scaling down the post-preparation 3D scan data 423 of the object and the 3D scan data 425 of the mandible included in the acquired data display region 420.

In an embodiment, the data processing apparatus 120a may acquire a library tooth (Maxilla Library) 421, which is necessary for designing a prosthesis for the object based on the selection of the first module, and may output the library tooth 421 to the acquired data display region 420. The library tooth 421 may be a previously-designed virtual sample corresponding to the number of the object included in the maxilla. Alternatively, the library tooth 421 may be data acquired by scanning another person's tooth having the same number as the number of the object. The library tooth 421 may be obtained from the memory 129, a database, an external server, or the like. The data processing apparatus 120a may search for and acquire the library tooth 421 corresponding to a target tooth based on the selection of the first module, and may output the library tooth 421 to the acquired data display region 420.

Alternatively, in another embodiment, when the first module is selected, the data processing apparatus 120a may output the library tooth 421 only to the allocated data display region 430 without outputting the library tooth 421 to the acquired data display region 420.

In an embodiment, a user may use data move buttons 440 to move data between the acquired data display region 420 and the allocated data display region 430. For example, when a user intends to design a prosthesis without using the 3D scan data 425 of the mandible, a user may select the data move buttons 440 to move the 3D scan data 425 of the mandible from the allocated data display region 430 to the acquired data display region 420 on the first module selection interface screen 400 shown in FIG. 4.

In an embodiment, when a user selects the confirm button 450, the data processing apparatus 120a may design a first prosthesis for the object according to the first module by using the data included in the allocated data display region 430. The data processing apparatus 120a may activate the confirm button 450 only when the post-preparation 3D scan data 423 of the object is included in the allocated data display region 430 based on the selection of the first module. The data processing apparatus 120a may design a first prosthesis for the object by using the post-preparation 3D scan data of the object, the library tooth 421, and the 3D scan data 425 of the mandible which are included in the allocated data display region 430.

In an embodiment, the data processing apparatus 120a may design the outer surface of the first prosthesis by using the outer surface of the library tooth 421, and the inner surface of the first prosthesis by using the post-preparation 3D scan data 423 of the object. In addition, the data processing apparatus 120a may use the 3D scan data 425 of the mandible to remove an interference region of the first prosthesis which interferes with the opposite dental arch or the antagonist tooth.

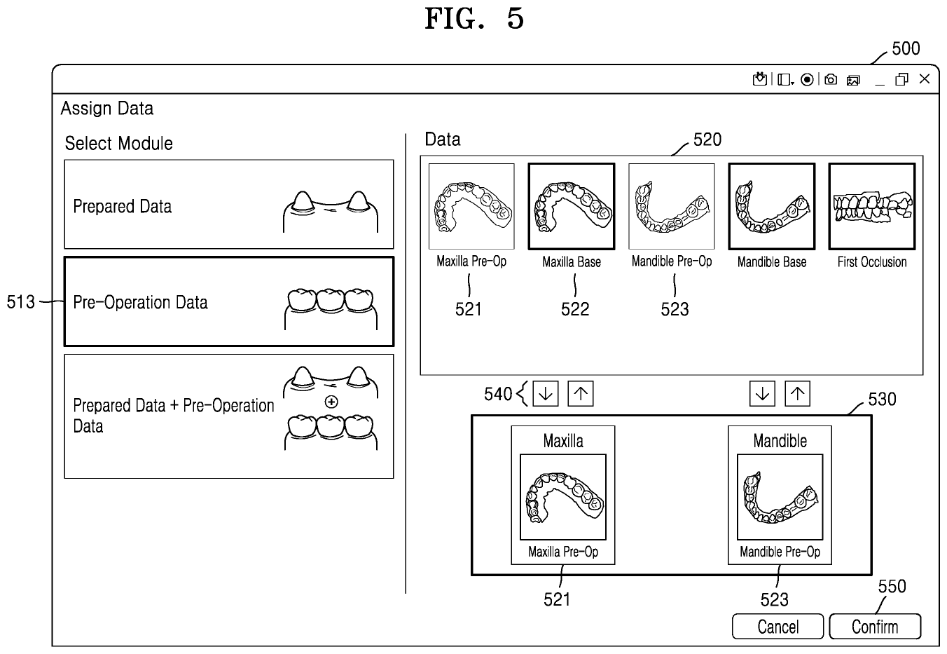

FIG. 5 is a view illustrating a second module selection interface screen 500 output by the data processing apparatus 120a according to an embodiment.

In an embodiment, when the second module is selected, the data processing apparatus 120a may output the second module selection interface screen 500 as shown in FIG. 5.

In an embodiment, the data processing apparatus 120a may automatically select the second module from the plurality of modules based on the type of 3D oral models.

In an embodiment, the second module may design a single crown in the form of an eggshell by using pre-preparation 3D scan data of an object. Because the second module may design only the outer surface of a second prosthesis by using the pre-preparation 3D scan data of the object without considering the inner surface of the second prosthesis, the second prosthesis may be quickly designed. However, because the inner surface of the second prosthesis is not considered when the second prosthesis is generated, the second prosthesis may not be used as a final prosthesis but may be used only as a temporary prosthesis.

In an embodiment, the data processing apparatus 120a may determine whether data essential for designing the second prosthesis by using the second module is included in the 3D oral models. In an embodiment, the data essential for designing the second prosthesis for the object by using the second module may be pre-preparation 3D scan data of the object.

In an embodiment, when data contained in an acquired data display region 520 includes the pre-preparation 3D scan data of the object but does not include post-preparation 3D scan data of the object, the data processing apparatus 120a may automatically select the second module.

Alternatively, in another embodiment, a user may select a second module selection button 513 by using a control device. When the data processing apparatus 120a receives a user input commanding the selection of the second module selection button 513, the data processing apparatus 120a may determine whether pre-preparation 3D scan data of the object is included in 3D oral models in the acquired data display region 520, and when it is determined that the pre-preparation 3D scan data of the object is included in the 3D oral models, the data processing apparatus 120a may allow the selection of the second module selection button 513.

In an embodiment, when the data processing apparatus 120a receives a user's input commanding the selection of the second module selection button 513 in a state in which the pre-preparation 3D scan data of the object is not included in the data contained in the acquired data display region 520, the data processing apparatus 120a may ignore the user's input commanding the selection of the second module selection button 513, or may output a message stating that the second module selection button 513 is not selectable or a message stating that the pre-preparation 3D scan data of the object is necessary for selecting the second module selection button 513. Alternatively, the data processing apparatus 120a may deactivate a confirm button 550 to prevent the selection of the confirm button 550.

In an embodiment, among data contained in the acquired data display region 520, the data processing apparatus 120a may identify data usable for designing the second prosthesis for the object by using the second module. In an embodiment, the data usable for designing the second prosthesis for the object by using the second module may further include 3D scan data of a dental arch opposite to the object or 3D scan data of occlusion in addition to the pre-preparation 3D scan data of the object. The 3D scan data of the dental arch opposite to the object may include 3D scan data of an antagonist tooth that occludes with the object. However, the 3D scan data of the opposite dental arch or occlusion may be optional data.

In an embodiment, when the second module is selected, the data processing apparatus 120a may automatically output the data usable for generating the second prosthesis to an allocated data display region 530.

In an embodiment, based on the selection of the second module, the data processing apparatus 120a may move, to the allocated data display region 530, a 3D oral model to be used for designing the second prosthesis among the 3D oral models included in the acquired data display region 520.

In FIG. 5, it is assumed that an object to be restored with a prosthesis is included in the maxilla. Based on the selection of the second module, the data processing apparatus 120a may move, from the acquired data display region 520 to the allocated data display region 530, pre-preparation 3D scan data (Maxilla Pre-Op) 521 of the object which is essential data for designing the second prosthesis for the object by using the second module. In addition, the data processing apparatus 120a may move, to the allocated data display region 530, 3D scan data (Mandible Pre-Op) 523 of the opposite dental arch (mandible) contained in the acquired data display region 520.

In an embodiment, a user may use data move buttons 540 to move data between the acquired data display region 520 and the allocated data display region 530.

In an embodiment, when a user selects the second module selection button 513 in a state in which the 3D oral models in the acquired data display region 520 include the pre-preparation 3D scan data 521 of the object and post-preparation 3D scan data 522 of the object, the data processing apparatus 120a may move only the pre-preparation 3D scan data 521 of the object from the acquired data display region 520 to the allocated data display region 530 without moving the post-preparation 3D scan data 522 of the object from the acquired data display region 520.

Thereafter, a user may select the confirm button 550. In an embodiment, based on the selection of the second module, the data processing apparatus 120a may activate the confirm button 550 to allow the selection of the confirm button 550 only when the pre-preparation 3D scan data 521 of the object is included in the allocated data display region 530.

When the confirm button 550 is selected, the data processing apparatus 120a may design the second prosthesis for the object by using 3D scan data contained in the allocated data display region 530 according to the second module.

In an embodiment, the data processing apparatus 120a may design the outer surface of the second prosthesis for the object by using the pre-preparation 3D scan data 521 of the object. In addition, the data processing apparatus 120a may design the second prosthesis by using the 3D scan data 523 of the mandible such that the second prosthesis may not have an interference region at an occluding position.

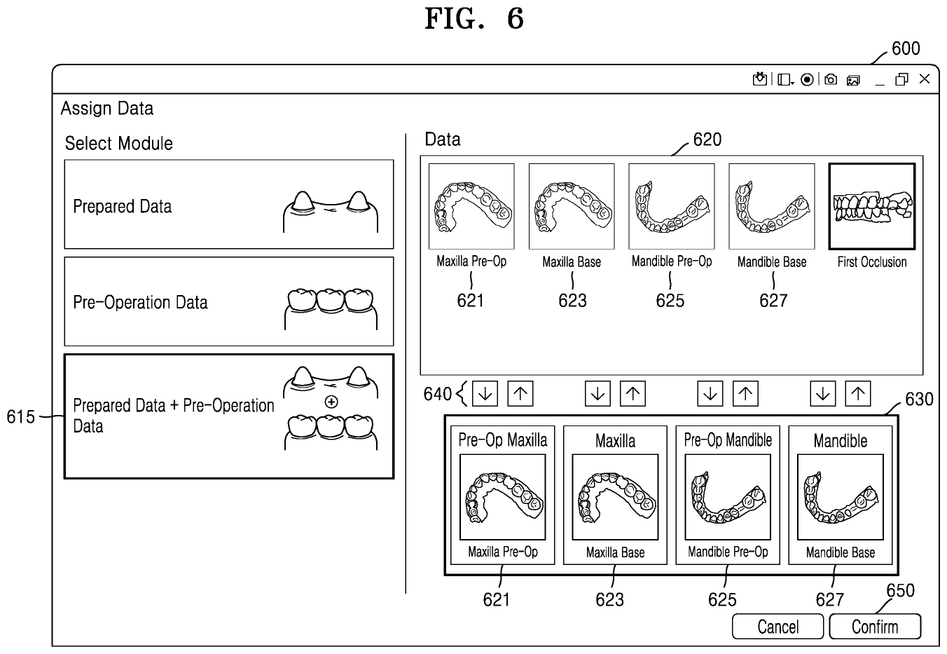

FIG. 6 is a view illustrating a third module selection interface screen 600 output by the data processing apparatus 120a according to an embodiment.

In an embodiment, when the third module is selected, the data processing apparatus 120a may output the third module selection interface screen 600 as shown in FIG. 6.

In an embodiment, the data processing apparatus 120a may automatically select the third module from the plurality of modules based on the type of 3D oral models.

In an embodiment, the third module may be a module for generating a temporary crown by using pre-preparation 3D scan data of an object and post-preparation 3D scan data of the object together. Because a third prosthesis is designed by using the pre-preparation 3D scan data of the object and the post-preparation 3D scan data of the object together, the third prosthesis may be designed not only on the outer surface of the tooth, but also on the inner surface of the tooth by considering a post-preparation tooth. Therefore, the third prosthesis may more precisely restore a prepared tooth of a patient than the second prosthesis. The third prosthesis may be manufactured as a product and may be used as a temporary tooth for restoring and protecting the object. Alternatively, the third prosthesis may be manufactured as a product through additional design modifications by using a ceramic, gold, or other materials, and after the object is restored with the third prosthesis, the third prosthesis may be additionally processed as a final prosthesis.

In an embodiment, the data processing apparatus 120a may determine whether data definitely essential for designing the third prosthesis by using the third module is included in acquired 3D oral models. In an embodiment, data definitely essential for designing the third prosthesis by using the third module may be the pre-preparation 3D scan data of the object and the post-preparation 3D scan data of the object.

In an embodiment, when 3D oral models contained in an acquired data display region 620 include both the pre-preparation 3D scan data of the object and the post-preparation 3D scan data of the object, the data processing apparatus 120a may automatically select the third module.

In another embodiment, the data processing apparatus 120a may receive a user's input commanding the selection of a third module selection button 615. When the 3D oral models contained in the acquired data display region 620 include both the pre-preparation 3D scan data of the object and the pre-preparation 3D scan data of the object, the data processing apparatus 120a may allow the selection of the third module selection button 615.

In an embodiment, 3D scan data usable for designing the third prosthesis for the object by using the third module may be identified by the data processing apparatus 120a from the 3D oral models contained in the acquisition data display region 620.

In an embodiment, 3D scan data necessary for designing the third prosthesis for the object with the third module may further include 3D scan data of a dental arch opposite to the object and 3D scan data of occlusion in addition to the pre-preparation 3D scan data of the object and the post-preparation 3D scan data of the object. However, this is optional, and in designing the third prosthesis, 3D scan data of the opposite dental arch or an antagonist tooth included in the opposite dental arch, or 3D scan data of occlusion is not definitely required.

In an embodiment, when the third module is selected, the data processing apparatus 120a may move, to an allocated data display region 630, a 3D oral model to be used for generating the third prosthesis among the 3D oral models included in the acquired data display region 620. When the object is located in the maxilla, the data processing apparatus 120a may move, from the acquired data display region 620 to the allocated data display region 630, pre-preparation 3D scan data (Maxilla Pre-Op) 621 obtained by scanning the maxilla before preparation and post-preparation 3D scan data (Maxilla Base) 623 obtained by scanning the maxilla after preparation which are data essential for generating the third prosthesis by using the third module. In addition, the data processing apparatus 120a may move, to the allocated data display region 630, 3D scan data of the mandible (dental arch opposite to the maxilla), that is, pre-preparation 3D scan data (Mandible Pre-Op) 625 acquired by scanning the mandible before preparation.

In an embodiment, a user may data move buttons 640 to move 3D scan data between the acquired data display region 620 and the allocated data display region 630.

In an embodiment, the object may be one tooth or a plurality of teeth. The case in which the object is a tooth may be referred to as a single case, and the case in which the object includes a plurality of teeth may be referred to as a multi-case. For a multi-case, the data processing apparatus 120a may design one or more prostheses for a plurality of teeth.

For example, when the object includes two teeth included in the maxilla, the data processing apparatus 120a may design one or two prostheses for the two teeth included in the maxilla together. To this end, the data processing apparatus 120a may require: pre-preparation 3D scan data of the object, which is obtained by scanning the two teeth included in the maxilla before preparing the two teeth; and post-preparation 3D scan data of the object, which is obtained by scanning the two teeth after preparing the two teeth. The data processing apparatus 120a may generate the third prosthesis by designing prostheses for the two teeth by using the pre-preparation 3D scan date and the post-preparation 3D scan data together.

According to an embodiment, in an example multi-case, some teeth of the object may be in included in the maxilla, and the other teeth of the object may be included in the mandible. In the embodiment, the data processing apparatus 120a may design prostheses together for teeth of the object included in the maxilla and teeth of the object included in the mandible. The data processing apparatus 120a may design prostheses together for the teeth of the object included in the maxilla and the teeth of the object included in the mandible by using: 3D scan data obtained by scanning the teeth of the object in the maxilla before and after the teeth are prepared; and 3D scan data obtained by scanning the teeth of the object in the mandible before and after the teeth are prepared.

In an embodiment, when a portion of the object is included in the maxilla and the other portion of the object is included in the mandible, the data processing apparatus 120a may design a prosthesis having no portion interfering with the object by using: pre-preparation 3D scan data of the mandible (dental arch) opposite to the maxilla; and pre-preparation 3D scan data of the maxilla (dental arch) opposite to the mandible.

In FIG. 6, it is assumed that the object is included in both the maxilla and the mandible. As shown in the acquired data display region 620 of FIG. 6, the 3D scan data acquired by the data processing apparatus 120a may include: 3D scan data (Maxilla Pre-Op) 621 acquired by scanning the maxilla before preparation; 3D scan data (Maxilla Base) 623 acquired by scanning the maxilla after preparation; 3D scan data (Mandible Pre-Op) 625 acquired by scanning the mandible before preparation; and 3D scan data (Mandible Base) 627 acquired by scanning the mandible after preparation.

In an embodiment, based on the selection of the third module, the data processing apparatus 120a may move, to the allocated data display region 630, a 3D oral model to be used for generating the third prosthesis among the 3D oral models contained in the acquired data display region 620.

In an embodiment, the data processing apparatus 120a may move the 3D scan data (Maxilla Pre-Op) 621 acquired by scanning the maxilla before preparation and the 3D scan data (Maxilla Base) 623 acquired by scanning the maxilla after preparation from the acquired data display region 620 to the allocated data display region 630 in order to design a third prosthesis for an object included in the maxilla. In addition, the data processing apparatus 120a may move the 3D scan data (Mandible Pre-Op) 625 acquired by scanning the mandible (dental arch) opposite to the maxilla before preparation from the acquired data display region 620 to the allocated data display region 630 in order to design the third prosthesis for the object included in the maxilla.

In addition, the data processing apparatus 10a may move, from the acquired data display region 620 to the allocated data display region 630, the 3D scan data (Mandible Pre-Op) 625 acquired by scanning the mandible before preparation, the 3D scan data (Mandible Base) 627 acquired by scanning the mandible after preparation, and the 3D scan data (Maxilla Pre-Op) 621 acquired by scanning the maxilla (dental arch) opposite to the mandible before preparation, in order to design a third prosthesis for an object included in the mandible.

In response to the selection of a confirm button 650, the data processing apparatus 120a may design a 3D prosthesis by using data included in the allocated data display region 630. For example, the data processing apparatus 120a may design a third prosthesis for an object included in the maxilla by using, as essential data, the 3D scan data (Maxilla Pre-Op) 621 acquired by scanning the maxilla before preparation and the 3D scan data (Maxilla Base) 623 acquired by scanning the maxilla after preparation, and as additional data, the 3D scan data (Mandible Pre-Op) 625 acquired by scanning the mandible before preparation. In addition, the data processing apparatus 120a may design a third prosthesis for an object included in the mandible by using, as essential data, the 3D scan data (Mandible Pre-Op, 625) acquired by scanning the mandible before preparation and the 3D scan data (Mandible Base, 627) acquired by scanning the prepared mandible, and as additional data, the scan 3D scan data (Maxilla Pre-Op, 621) obtained by scanning the maxilla before preparation.

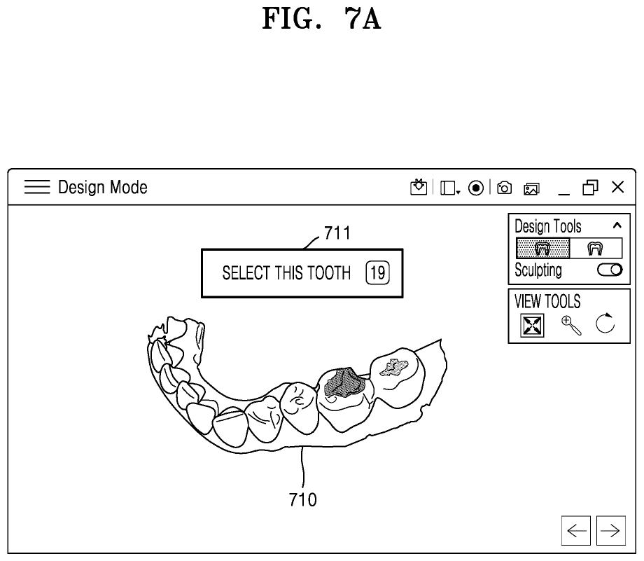

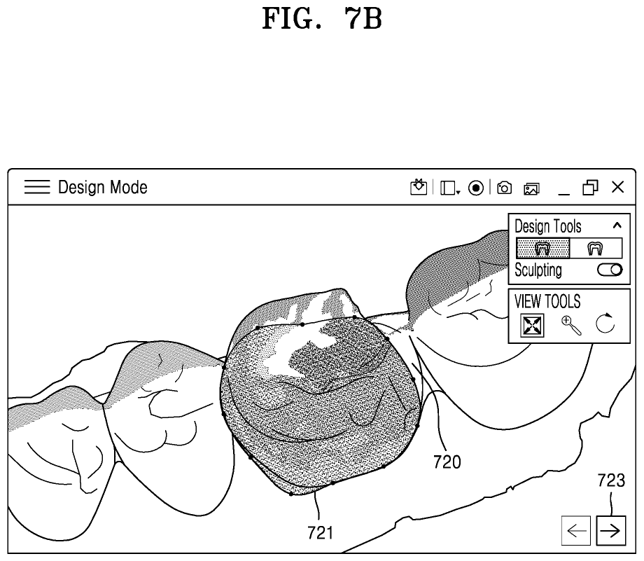

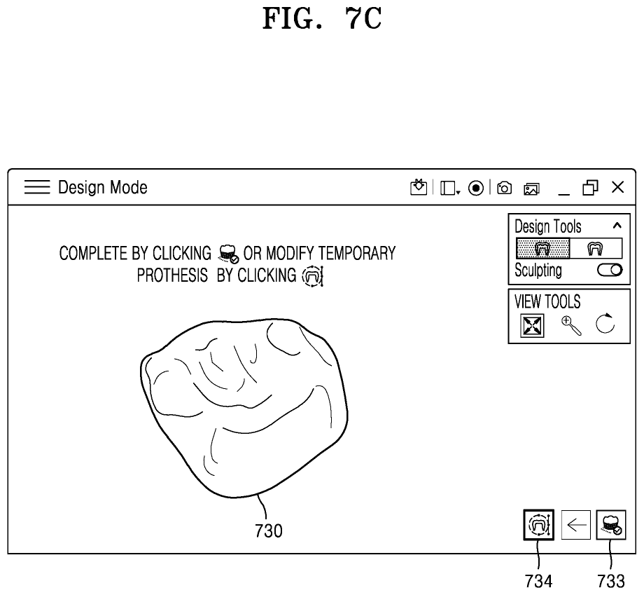

FIGS. 7A to 7C are views illustrating how the data processing apparatus 120a designs a second prosthesis using the second module according to and embodiments.

In an embodiment, when the second module is selected, the data processing apparatus 120a may output pre-preparation 3D scan data of an object on a screen.

FIG. 7A is a view illustrating that the data processing apparatus 120a outputs pre-preparation 3D scan data 710 of the object based on the selection of the second module. The data processing apparatus 120a may output guide information 711 indicating which tooth the object to be treated is, together with the pre-preparation 3D scan data 710. The guide information 711 may be about on a target tooth, which is previously input by a user using the data processing apparatus 120a. In FIG. 7A, the guide information 711 shows a tooth number, that is, 19. However, the present disclosure is not limited thereto, and the guide information 711 may be output in various forms.

The guide information 71 may inform a user of a tooth number to be treated among the pre-preparation 3D scan data 710. When a user selects an object to be treated from the pre-preparation 3D scan data 710, the data processing apparatus 120a may generate a virtual margin line for the object selected by the user from the pre-preparation 3D scan data 710.

FIG. 7B is a view illustrating that the data processing apparatus 120a generates a virtual margin line. When a user selects an object 720, the data processing apparatus 120a may automatically generate a virtual margin line 721 for the selected object 720. The virtual margin line 721 may be a line predicted by the data processing apparatus 120a and corresponding to an actual margin line between an actual target tooth and an actual gingiva. The data processing apparatus 120a may generate the virtual margin line 721 between the target tooth, which is included in the object 720 and is to be restored with a prosthesis, and the gingiva adjacent to the target tooth.

The data processing apparatus 120a may identify points included in a region corresponding to the boundary between the target tooth and the gingiva, and may connect a plurality of points to generate the virtual margin line 721. A user may modify or edit the virtual margin line 721 generated by the data processing apparatus 120a.

Thereafter, when a user selects a next button 723, the data processing apparatus 120a may design the outer surface of the object to generate a second prosthesis. FIG. 7C illustrates a second prosthesis 730 designed by the data processing apparatus 120a. Referring to FIG. 7C, the data processing apparatus 120a may design the second prosthesis 730 by using the pre-preparation 3D scan data 710 of the object and the virtual margin line 721. For example, the data processing apparatus 120a may design the second prosthesis 730 such that the second prosthesis 730 may have the outer surface of the pre-preparation 3D scan data 710 of the object above the virtual margin line 721. A user may select a completion button 733 to end the design work of the second prosthesis 730, or may select an edit button 734 to further modify and/or edit the second prosthesis 730.

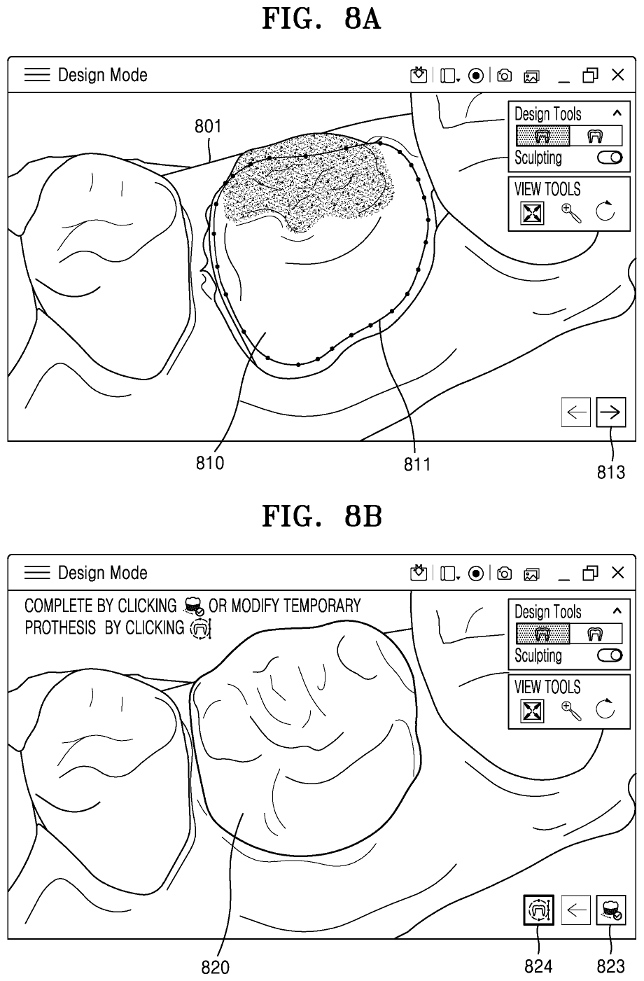

FIGS. 8A and 8B are views illustrating how the data processing apparatus 120a generates a third prosthesis 820 using the third module according to an embodiment.

In an embodiment, when the third module is selected, the data processing apparatus 120a may output post-preparation 3D scan data of an object on the screen.

FIG. 8A is a view illustrating that the data processing apparatus 120a outputs post-preparation 3D scan data 801 of an object 810 based on the selection of the third module.

In an embodiment, when the post-preparation 3D scan data 801 of the object 810 is acquired, a virtual margin line 811 may be generated together on the object 810. When the virtual margin line 811 has already been generated for the object 810, the data processing apparatus 120a may output the post-preparation 3D scan data 801 of the object 810 based on the selection of the third module while outputting the virtual margin line 811 together with the post-preparation 3D scan data.

In an embodiment, the data processing apparatus 120a may output the virtual margin line 811 such that the virtual margin line 811 may overlap the object 810 which is identified.

FIG. 8A illustrates that the data processing apparatus 120a outputs the virtual margin line 811 on the identified object 810 in an overlapping manner.

In an embodiment, when the virtual margin line 811 is not previously generated for the object 810, the data processing apparatus 120a may output a screen on which the object 810 is selectable. When the screen on which the object 810 is selectable is output, a user may select the object 810, which is to be treated, from the post-preparation 3D scan data 801 of the object 810. When the object 810 is selected, the data processing apparatus 120a may automatically generate the virtual margin line 811 for the object 810.

Thereafter, when a user selects a next button 813, the data processing apparatus 120a may generate the third prosthesis 820 for the object 810.

FIG. 8B illustrates that the data processing apparatus 120a designs the third prosthesis 820. Referring to FIG. 8B, the data processing apparatus 120a may design the prosthesis 820 for the object 810 by using pre-preparation 3D scan data of the object 810, the post-preparation 3D scan data 801 of the object, and the virtual margin line 811. The data processing apparatus 120a may generate the third prosthesis 820 with reference to the virtual margin line 811by designing the outer surface of the third prosthesis 820 based on the pre-preparation 3D scan data of the object 810, and designing the inner surface of the third prosthesis 820 based on the post-preparation 3D scan data 801 of the object 810. A user may select a completion button 823 to end the design work of the third prosthesis 820, or may select an edit button 824 to further modify and/or edit the third prosthesis 820.

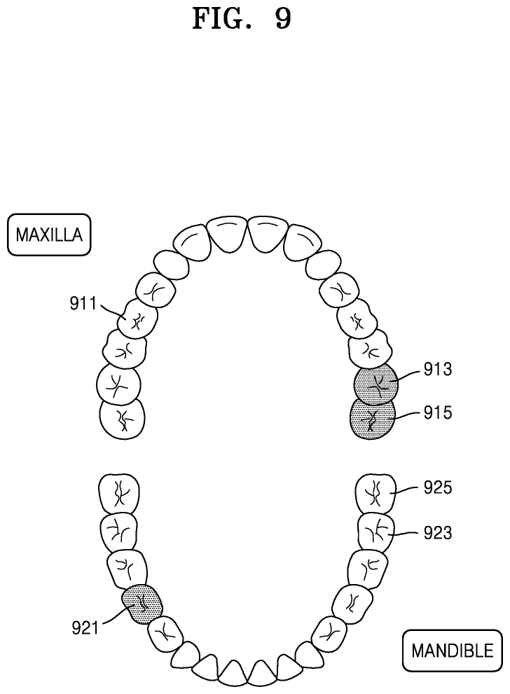

FIG. 9 is a view illustrating a multi-case in which an object includes a plurality of teeth.

In an embodiment, the object may include a plurality of teeth.

FIG. 9 illustrates an example case in which an object to be treated includes a first tooth 913 and a second tooth 915 among teeth included in the maxilla, and a third tooth 921 among teeth included in the mandible.

In an embodiment, the data processing apparatus 120a may simultaneously design prostheses for the first tooth 913, the second tooth 915, and the third tooth 921.

In an embodiment, when patient's teeth are not prepared, a user may acquire pre-preparation 3D scan data of the object by the 3D scanner 110 before the patient's teeth are prepared. The user may scan the object included in the maxilla and the object included in the mandible by the 3D scanner 110, thereby generating pre-preparation 3D scan data of the maxilla including the first tooth 913 and the second tooth 915 which are not prepared, and pre-preparation 3D scan data of the mandible including the third tooth 921 which is not prepared. When the pre-preparation 3D scan data of the maxilla includes an antagonist tooth 911 with which the third tooth 921 occludes, the data processing apparatus 120a may use the pre-preparation 3D scan data of the maxilla as antagonist tooth scan data with respect to the third tooth 921. In addition, when the pre-preparation 3D scan data of the mandible includes antagonist teeth 923 and 925 with which the first and second teeth 913 and 915 occlude, the data processing apparatus 120a may use the pre-preparation 3D scan data of the mandible as antagonist tooth scan data with respect to the first and second teeth 913 and 915.

In an embodiment, when only the pre-preparation 3D scan data of the object is available and post-preparation 3D scan data of the object is not available, the data processing apparatus 120a may design a second prosthesis for the object according to the second module. The data processing apparatus 120a may use the pre-preparation 3D scan data of the object and 3D scan data of antagonist teeth. That is, the data processing apparatus 120a may simultaneously design eggshell-shaped second prostheses having pre-preparation object outer surfaces respectively for the first tooth 913, the second tooth 915, and the third tooth 921.

In an embodiment, when the object is in a prepared state, a user may acquire post-preparation 3D scan data of the object using a 3D intraoral scanner.

In an embodiment, the pre-preparation 3D scan data of the object may not be available, and only the post-preparation 3D scan data of the object may be available. In this case, the data processing apparatus 120a may design a first prosthesis according to the first module. The data processing apparatus 120a may acquire library teeth respectively for the first tooth 913, the second tooth 915, and the third tooth 921 which are prepared. The data processing apparatus 120a may use the prepared first tooth 913, the prepared second tooth 915, a library tooth corresponding to the prepared first tooth 913, and a library tooth corresponding to the prepared second tooth 915 in order to design first prostheses having library-tooth outer surfaces and prepared-object inner surfaces for the first and second teeth 913 and 915. At the same time, the data processing apparatus 120a may use 3D scan data of the prepared third tooth 921 and the library tooth corresponding to the prepared third tooth 921 in order to design a first prosthesis having a library-tooth outer surface and a prepared-object inner surface for the third tooth 921.

In an embodiment, when both the pre-preparation 3D scan data of the object and the post-preparation 3D scan data of the object are available, the data processing apparatus 120a may design a third prosthesis for the object according to the third module. The data processing apparatus 120a may use the pre-preparation 3D scan data of the maxilla, the pre-preparation 3D scan data of the mandible, the post-preparation 3D scan data of the maxilla, and the post-preparation 3D scan data of the mandible together in order to design third prostheses having pre-preparation object outer surfaces and post-preparation object inner surfaces respectively for the first tooth 913, the second tooth 915, and the third tooth 921.

As described above, according to embodiments, the data processing apparatus 120a may rapidly generate prostheses having a desired shape by simultaneously designing the prostheses for a plurality of objects.

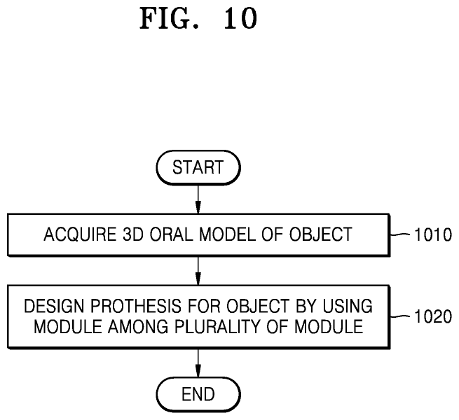

FIG. 10 is a flowchart illustrating a data processing method according to an embodiment.

Referring to FIG. 10, the data processing apparatus 120a may acquire a 3D oral model of an object (operation 1010).

In an embodiment, the 3D oral model of the object may include 3D scan data of the object. The 3D scan data of the object may include at least one piece of data selected from the group consisting of pre-preparation 3D scan data of the object and post-preparation 3D scan data of the object.

In an embodiment, the data processing apparatus 120a may select one module from a plurality of modules based on the type of the 3D scan data of the object included in the 3D oral model.

In an embodiment, the data processing apparatus 120a may design a prosthesis for the object by using one module among the plurality of modules (operation 1020).

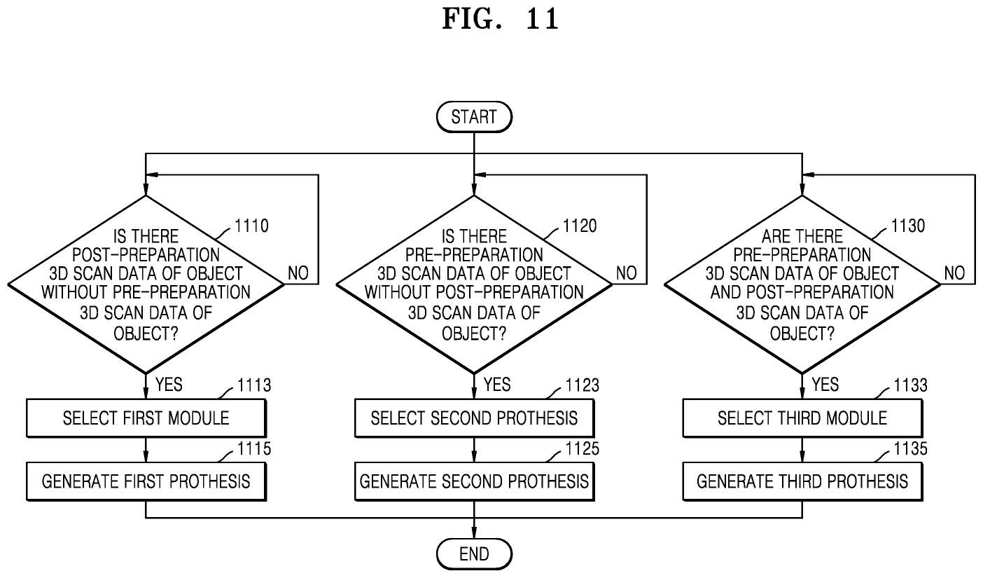

FIG. 11 is a flowchart illustrating a method of selecting one module from a plurality of modules according to an embodiment.

Referring to FIG. 11, the data processing apparatus 120a may identify the type of 3D scan data of an object to select one module from a plurality of modules.

In an embodiment, when the data processing apparatus 120a determines that available 3D scan data includes post-preparation 3D scan data of the object but does not include pre-preparation 3D scan data of the object (operation 1110), the data processing apparatus 120a may select a first module (operation 1113).

In an embodiment, the data processing apparatus 120a may generate a first prosthesis based on the selection of the first module (operation 1115). The data processing apparatus 120a may acquire a library tooth corresponding to the object based on the selection of the first module. The data processing apparatus 120a may generate the first prosthesis by using the library tooth as the outer surface of the first prosthesis and forming the inner surface of the first prosthesis based on the post-preparation 3D scan data of the object.

In an embodiment, when the data processing apparatus 120a determines that the available 3D scan data includes the pre-preparation 3D scan data of the object but does not include the post-preparation 3D scan data of the object (operation 1120), the data processing apparatus 120a may select a second module (operation 1123).

In an embodiment, the data processing apparatus 120a may generate a second prosthesis based on the selection of the second module (operation 1125). The data processing apparatus 120a may generate the second prosthesis by forming the outer surface of the second prosthesis based on the pre-preparation 3D scan data of the object.

In an embodiment, when the data processing apparatus 120a determines that the available 3D scan data includes both the post-preparation 3D scan data of the object and the pre-preparation 3D scan data of the object (operation 1130), the data processing apparatus 120a ma select a third module (operation 1133).

In an embodiment, the data processing apparatus 120a may generate a third prosthesis based on the selection of the third module (operation 1135). The data processing apparatus 120a may generate the third prosthesis by forming the outer surface of the third prosthesis based on the pre-preparation 3D scan data of the object and forming the inner surface of the third prosthesis based on the post-preparation 3D scan data of the object.

In an embodiment, the data processing method may be implemented in the form of program instructions executable by various computers and may be recorded on a computer-readable recording medium. Also, an embodiment may provide a computer-readable recording medium on which at least one program including at least one instruction for executing the data processing method is recorded.

In addition, according to the embodiments described above, the data processing method may include: obtaining a 3D oral model including 3D scan data of an object; and generating a prosthesis for the object based on the 3D scan data of the object according to a module selected from a plurality of modules, and the data processing method may be implemented as a computer program product including a computer-readable recording medium on which a program for implementing the data processing method is recorded.

Each of the computer-readable recording media may include program instructions, data files, data structures or the like alone or in combination. Examples of the computer-readable recording media may include: magnetic media such as hard disks, floppy disks, and magnetic tapes; optical recording media such as CD-ROMs and DVDs; magneto-optical media such as floptical disks; and hardware such as ROMs, RAMs, and flash memories specifically configured to store program instructions and execute the program instructions.

Here, the computer-readable recording media may be provided in the form of non-transitory recording media. Here, the “non-transitory recording media” may refer to tangible recording media. Also, the “non-transitory recording media” may include buffers in which data is temporarily stored.

In some embodiments, the data processing method according to the various embodiments described above may be included in a computer program product. The computer program product may be distributed in the form of a machine-readable recording medium (for example, compact disc read only memory (CD-ROM)). In addition, the computer program product may be distributed online (for example, downloaded or uploaded) through application stores (for example, Play Store, etc.) or directly between two user devices (for example, smartphones). According to embodiments, for example, the computer program product may include a recording medium on which a program including at least one instruction for executing the data processing method is recorded.

As described above, according to the data processing apparatus and the data processing method of the embodiments, prostheses may be generated for objects by using various modules.

According to the data processing apparatus and the data processing method of the embodiments, one module may be automatically selected from a plurality of modules according to the type of scan data.

According to the data processing apparatus and the data processing method of the embodiments, scan data necessary for generating a prosthesis for an object by using a selected module may be identified and displayed.

According to the data processing apparatus and the data processing method of the embodiments, prostheses may generated together for a plurality of objects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A data processing method using a data processing apparatus, the data processing method comprising:
obtaining a 3D oral model comprising 3D scan data of an object; and
generating a prosthesis for the object based on the 3D scan data of the object according to a module selected from a plurality of modules.

2. The data processing method of claim 1, further comprising selecting the module from the plurality of modules according to a type of the 3D scan data of the object.

3. The data processing method of claim 2, wherein the selecting of the module from the plurality of modules comprises selecting a first module on the basis that the 3D scan data of the object comprises post-preparation 3D scan data of the object and does not comprise pre-preparation 3D scan data of the object,
wherein the generating of the prosthesis comprises:
obtaining a library tooth corresponding to the object based on the selecting of the first module; and
generating a first prosthesis using the post-preparation 3D scan data of the object and the library tooth.

4. The data processing method of claim 2, wherein the selecting of the module from the plurality of modules comprises selecting a second module on the basis that the 3D scan data of the object comprises pre-preparation 3D scan data of the object and does not comprise post-preparation 3D scan data of the object,
wherein the generating of the prosthesis comprises generating a second prosthesis based on the selecting of the second module by using the pre-preparation 3D scan data of the object.

5. The data processing method of claim 2, wherein the selecting of the module from the plurality of modules comprises selecting a third module on the basis that the 3D scan data of the object comprises post-preparation 3D scan data of the object and pre-preparation 3D scan data of the object,
wherein the generating of the prosthesis comprises generating a third prosthesis based on the selecting of the third module by using the post-preparation 3D scan data of the object and the pre-preparation 3D scan data of the object.

6. The data processing method of claim 1, further comprising receiving a selection of one module from the plurality of modules from a user.

7. The data processing method of claim 1, further comprising identifying, from the 3D scan data included in the 3D oral model, 3D scan data necessary for generating the prosthesis for the object by using the selected module.

8. The data processing method of claim 7, wherein the 3D oral model comprises 3D scan data of a dental arch opposite to the arch including the object, and the dental arch comprises an antagonist tooth corresponding to the object,
wherein the identifying of the 3D scan data necessary for generating the prosthesis for the object comprises identifying the 3D scan data of the dental arch as the 3D scan data necessary for generating the prosthesis for the object.

9. The data processing method of claim 8, wherein the generating of the prosthesis for the object comprises generating the prosthesis for the object by using both the 3D scan data of the object and the 3D scan data of the dental arch.

10. The data processing method of claim 7, wherein the identifying of the 3D scan data necessary for generating the prosthesis for the object comprises identifying a type of the 3D scan data from identification information on the 3D scan data.

11. The data processing method of claim 10, wherein the type of the 3D scan data comprises at least one piece of information indicating whether the 3D scan data is about maxilla or mandible, or information indicating whether the 3D scan data is about a pre-preparation tooth or a post-preparation tooth.

12. The data processing method of claim 1, wherein, when the object comprises a plurality of objects, the generating of the prosthesis for the object comprises generating prostheses together for the plurality of objects.

13. The data processing method of claim 12, wherein, when a portion of the object is included in maxilla and another portion of the object is included in mandible, the generating of the prosthesis for the object comprises generating together a prosthesis for the portion of the object included in the maxilla and a prosthesis for the other portion of the object included in the mandible.

14. A data processing apparatus comprising at least one processor configured to execute at least one instruction,
wherein the at least one processor is configured to: execute the at least one instruction to obtain a 3D oral model comprising 3D scan data of an object; and generate a prosthesis for the object based on the 3D scan data of the object according to a module selected from a plurality of modules.
